(19) United States
(12) Patent Application Publication
(10) Pub. No.: US 2008/0145580 A1
(43) Pub. Date: Jun. 19, 2008

(54) RECYCLED MATERIAL INSULATION

(75) Inventors: William Templeton McAllister, Pittsburgh, PA (US); William Gale Vinton, Portland, OR (US)

Correspondence Address: Stolowitz Ford Cowger LLP, 621 SW Morrison St, Suite 600, Portland, OR, 97205, US

(73) Assignee: Insulastics Inc., Portland, OR (US)

(21) Appl. No.: 11/935,954

(22) Filed: Nov. 6, 2007

Related U.S. Application Data
(60) Provisional application No. 60/857,587, filed on Nov. 7, 2006.

(51) Int. Cl. B32B 1/06; B32B 5/02; E04C 2/34; F16L 9/14; E04G 11/00; B32B 1/08

(52) U.S. Cl. 428/36.4; 428/357; 428/212; 428/34.1; 52/794.1; 249/13; 138/149

(57) ABSTRACT

A recycled insulation material includes plastic and/or rubber shredded or chopped up into individual pieces having random or semi-random sizes and lengths that when combined together create random or semi-random air-pockets in-between many of the individual pieces. The shredded or chopped up plastic and/or rubber pieces in combination with the air-pockets are configured to operate as an insulation filler for a variety of different panels, forms, pipes, conduits or any other item that requires insulation.

The present application claims priority to provisional application Ser. No. 60/857,587, filed Nov. 7, 2006, entitled Recycled Plastic Insulator, which is incorporated by reference in its entirety.

### BACKGROUND

As the cost of energy continues to increase, insulation becomes a more important building and construction material. One type of insulation uses fiberglass strands that are attached to one layer of paper or partially sandwiched between two layers of paper. Fiberglass insulation is difficult and messy to install and also has a tendency to leave fiberglass remnants throughout the area where the fiberglass is installed.

Fiberglass insulation is also unsightly and therefore generally needs to be covered up with sheetrock, wall boards, floor boards, paneling, etc. No one particularly cares to go near fiberglass insulation. Therefore, areas where fiberglass insulation is not covered up generally become un-utilized or under-utilized.

Some areas where fiberglass insulation is installed become unusable. For example, fiberglass insulation is often installed between the floor joists in attics but then the fiberglass is never covered up by floor boards. It is often undesirable to then place or store boxes and other materials on the fiberglass. For example, the fiberglass and paper covering is not sturdy enough to support a lamp or tall standing object. Further, the strands of fiberglass can often cling onto the articles placed directly on the soft sheets of fiberglass.

Fiberglass insulation is also very difficult to clean. Dust, dirt, and other contaminates often get engrained in the fiberglass strands and remain there for the lifetime of the insulation. Thus, areas with open fiberglass insulation are often generally dirty and unappealing. Breathing in fiberglass fibers can also pose a health problem similar to breathing in asbestos.

Of course, other types of insulation exist, such as insulating foams that are sprayed into the walls of homes. Foam insulation is difficult to install and must be squirted through a hole drilled in-between two walls of a building. Since the foam is sprayed out as a liquid, it is also difficult to control where the foam insulation is dispensed. For example, the foam may seep through cracks or openings in inside or outside walls creating an eyesore.

Any uncovered foam insulation has the same problems described above for fiberglass insulation. For example, the uncovered foam may break apart and attach to other items in the same room. Foam insulation is also difficult to clean, and uses raw materials that are not easily recycled.

Conventional fiberglass insulation and foam are also not necessarily the best insulators. For example, home owners often have to place multiple layers of fiberglass insulation on top of each other to adequately insulate a space. These double layers of insulation can be up to several feet thick further reducing the amount of useful room space.

### BRIEF DESCRIPTION OF THE DRAWINGS

FIG. 1 is an isometric view of an insulation panel that uses recycled plastic fill.

FIG. 2 is a cross-sectional view of recycled plastic pieces used as filler in the insulation panel shown in FIG. 1,

FIG. 3 is a cross-sectional view of an insulation panel that uses a flexible skin.

FIGS. 4-6 are cross-sectional views of the insulation panel in FIG. 3 in different compressed, stretched, and bent conditions.

FIGS. 7-10 are perspective views of the insulation panel in FIG. 3 shown in different compressed, stretched, and bent conditions.

FIG. 11 shows one example of how an adhesive may be applied to the shredded plastic pieces.

FIG. 12 shows an exploded view of an insulation panel with perpendicular ribbing.

FIG. 13 shows an exploded view of an insulation panel with diagonal ribbing.

FIGS. 14A-14D show an insulation panel skin with perpendicular ribbing and prefabricated thru-holes.

FIGS. 15A-15D shows an insulation panel skin with diagonal ribbing and prefabricated thru-holes.

FIG. 16 shows a plug inserted into one of the insulation panels.

FIGS. 17A-17C show how the insulation panels may connect together.

FIGS. 18A and 18B show how the insulation panels may be further attached together and attached to a support structure.

FIGS. 19 and 20 show how the insulation panels can be cut and capped.

FIGS. 21A and 21B show an insulation panel with an expandable baffle.

FIGS. 22-24 show how insulation forms and panels can be used with concrete.

FIGS. 25A-25D show an insulated conduit casing.

FIGS. 26A-26C show insulated piping.

### DETAILED DESCRIPTION

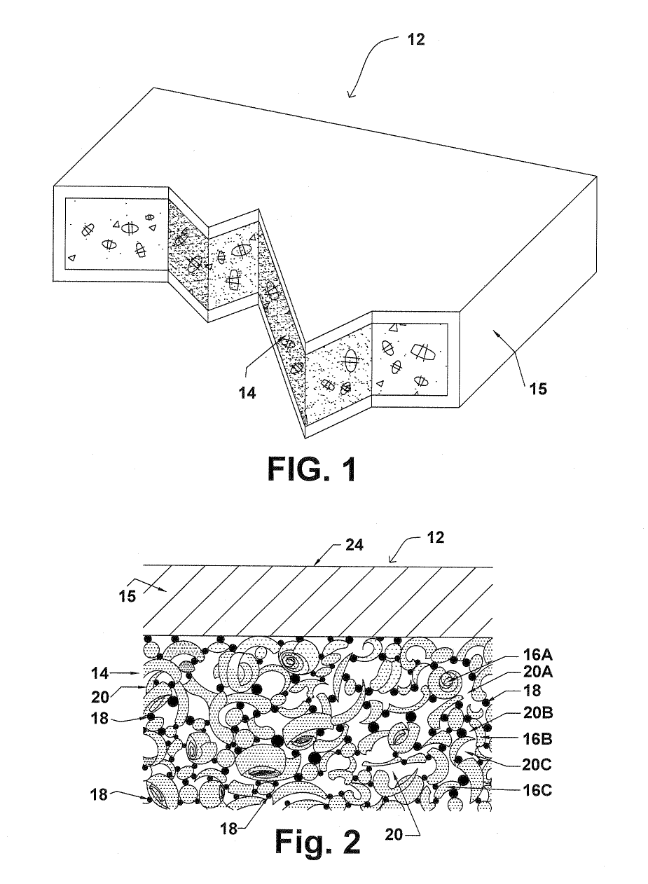

FIG. 1 shows a panel 12 containing a fill 14 that in one instance includes shredded recycled plastic pieces. The panel 12 includes a plastic skin, wall, or enclosure 15 that in one embodiment is also made of plastic. The skin 15 can be any thickness required for a particular application. In one embodiment, the skin 15 is made out of a rigid plastic that allows the panel 12 to be used as a stand-alone wall, ceiling, or floor. In another embodiment, the skin 15 is made from a relatively thin flexible tear-resistant plastic film that allows the entire panel 12 to flex, bend, and resiliently compress and expand. In yet another embodiment, the skin 15 in panel 12 may be a medium thickness and inserted in-between wall joists and then covered up by drywall. The skin 15 can be any thickness and the fill 14 can be any thickness. The plastic enclosure 15 can also be made using a fire retardant material.

### Shredded Recycled Plastic

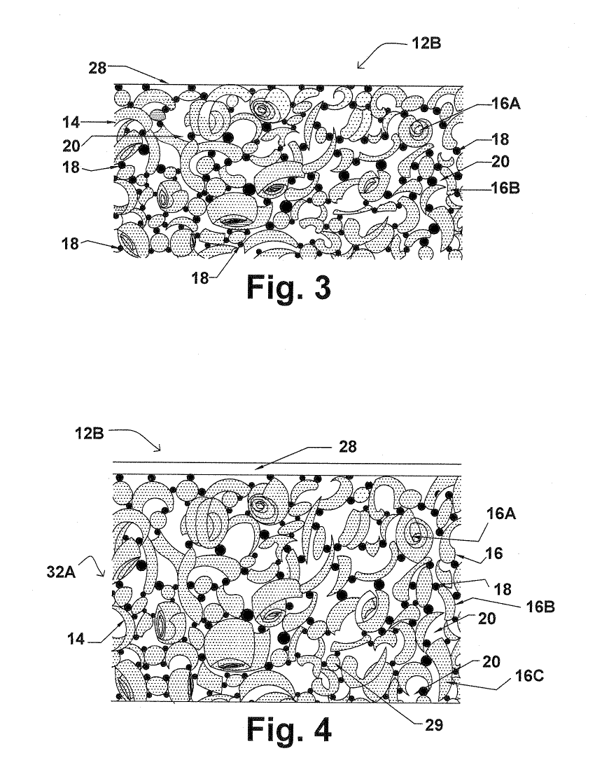

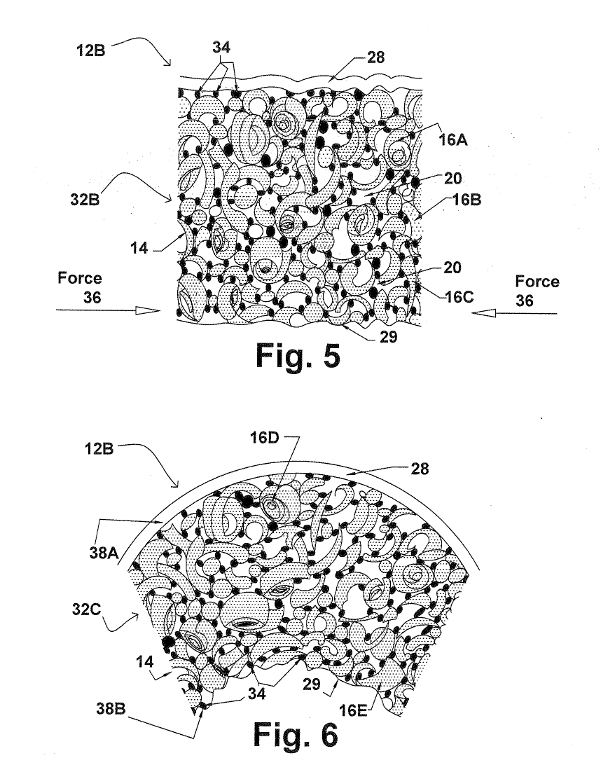

FIGS. 2 and 3 show one embodiment of the recycled plastic fill material 14 in more detail. Referring first to FIG. 2, the recycled fill material 14 can be made from any combination of recycled plastics, such as plastic bottles, plastic garbage bags, plastic grocery bags, or any other type of pliable or flexible plastic film. The fill material 14 can also include recycled rubber such as old tires, foam such as packing peanuts; and any other materials. In one embodiment it is preferable to use inorganic fill materials that generally do not decompose over time and that can be eliminated from landfills.

More rigid pieces of shredded or chopped plastic 16 can also be used, in addition to or instead of the plastic film material. For example, the shredded plastic 16 may come from used plastic bottles, and other plastic containers that may be thicker or have more rigidity than plastic films. Any combination of these shredded, chopped, shaved, diced or otherwise cut up recycled materials are referred to generally below as shredded plastic 16.

While not necessary, one embodiment of the fill 14 uses an adhesive 18, such as a polymer glue, that is sprayed on the shredded pieces of plastic 16. The glue holds the shredded plastic pieces both to each other and also to the inside walls of skin 15. In another embodiment, no adhesive is used, and the shredded plastic pieces 16 are simply suspended on top of each other.

The shredded plastic 16 can be any variety of shapes and sizes and are referred to generally as individual slivers, streamers, and/or bands. To promote differing shapes and sizes a plastic shredder may include multiple blades that are spaced different distances apart. The shredder may also include different types of cutting blades such as a thick serrated blade having teeth and another round blade with a single sharp circular edge similar to the blades used to cut deli meat. Some blades may be rotated at a higher speed than other blades or some blades may be aligned at different cutting angles. Of course these are all just examples of ways to promote more random non-uniformity in the shredded plastic pieces 16.

The nature of the plastic materials may also promote random shapes in the shredded plastic 16. For example, a plastic bottle may be fed into a shredder. The shredder may have multiple blades all of the same shape, size, and distance apart and that all operate at the same speed. The varying shapes of the plastic bottles and the varying angles that bottles feed into the blades may naturally create random sizes in the shredded plastic 16. For example, the narrow relatively thick neck of a plastic bottle may be shredded into shapes that are substantially different than the shape produced by the wider and thinner bottom section of the same plastic bottle. Further, if plastic bottles are shredded along with plastic bags and rubber tires, then each of these different materials may be shredded by the blades into different shapes.

As described above, the shredded plastic 16 may come in an almost limitless number of shapes and sizes. In one embodiment the shape and size of the shredded plastic pieces 16 promote large spaces or air gaps 20. For example, shredded plastic piece 16A has a curled nautilus shape, piece 6B has a semi-S-shape, and piece 16C has an arched concaved shape. Correspondingly, the air gaps 20A, 20B and 20C that are created between the plastic pieces 16A, 16B, and 16C also all have different random shapes.

### Reduced Thermal Bridging

A thermal bridge is created when materials that are poor insulators come in contact. The thermal bridge allows heat to flow through the path created by the poor insulators. Insulation around a thermal bridge provides little help in preventing heat loss or gain. The thermal bridging has to be eliminated or rebuilt either with a reduced cross-section or with materials that have better insulating properties.

The combination of randomly sized shredded or chopped plastic pieces 16 and relatively large randomly shaped, and randomly located air gaps 20 provide improved insulation characteristics that prevent thermal bridging. A relatively large space is filled with a relatively small amount of randomly shaped and randomly positioned shredded plastic pieces 16. These non-uniform plastic pieces 16 and corresponding non-uniform spaces or air gaps 20 in fill 14 prevent heat from passing through opposite sides of panel 12. This insulation characteristic is analogized with to goose down used in a coat. The down creates a relatively large amount of randomly separated air-pockets that prevent heat from passing through the coat walls.

In one example, the shredded plastic 16 is anywhere from around ⅛^{th} inch to around ½ inch long and anywhere from around ⅛^{th} inch to around ½ inch wide. This forms air gaps 20 that can generally be any size but could have widths, heights, and lengths of generally around ⅛^{th} inch to around ½ inch. Of course this is just one example, and the air gaps 20 can end up being almost any size and shape depending on how the shredded plastic lays or adheres together. Other sizes, shapes and types of shredded plastic 16 could be used to create generally smaller or larger air gaps 20. For example, the recycled plastic could be shredded into larger sliver and ribbon pieces 16 that are anywhere between 1 to 6 inches long and between 1 to 6 inches wide. In these applications, the larger shredded pieces 16 could create larger air gaps 20. Similarly, smaller air gaps could be created using smaller shredded plastic pieces. In each application, the filler will be shredded to the optimum size and filled to the best density to provide the maximum R-rating based on thermal testing.

FIG. 2 shows the panel 12 having a relatively thick plastic enclosure 15. Again, the enclosure 15 may be any thickness, but in one example, may be anywhere from around ⅛^{th} inch to around ½ inch thick. This allows the enclosure 15 to function as a rigid support structure that not only retains fill 14 but also allows the panel to be used as a free standing wall, ceiling, or floor.

The panel 12 in FIG. 2 can be inserted on top of floor joists in an attic and used as a floor for both walking on and for supporting boxes and other household or building items. Alternatively, the panels 12 could be inserted between wall joists and either covered up by drywall or left uncovered. In another application, the panel 12 can be stood upright and used as a stand-alone building wall that supports a roof or could be used as a self-supporting wall inside of a building that attaches to another interior wall. Some of these applications will be discussed in more detail below.

### Flexible Insulation Panels

FIG. 3 shows another embodiment of a panel 12B that uses a relatively thin skin 28. The skin 28 may be a thin tear-resistant plastic film of around 1/16^{th} of an inch or less. For example, the skin 28 may be similar to the thickness of a plastic bag or plastic wrap. Thin plastic tear resistant films are known and therefore not described in further detail.

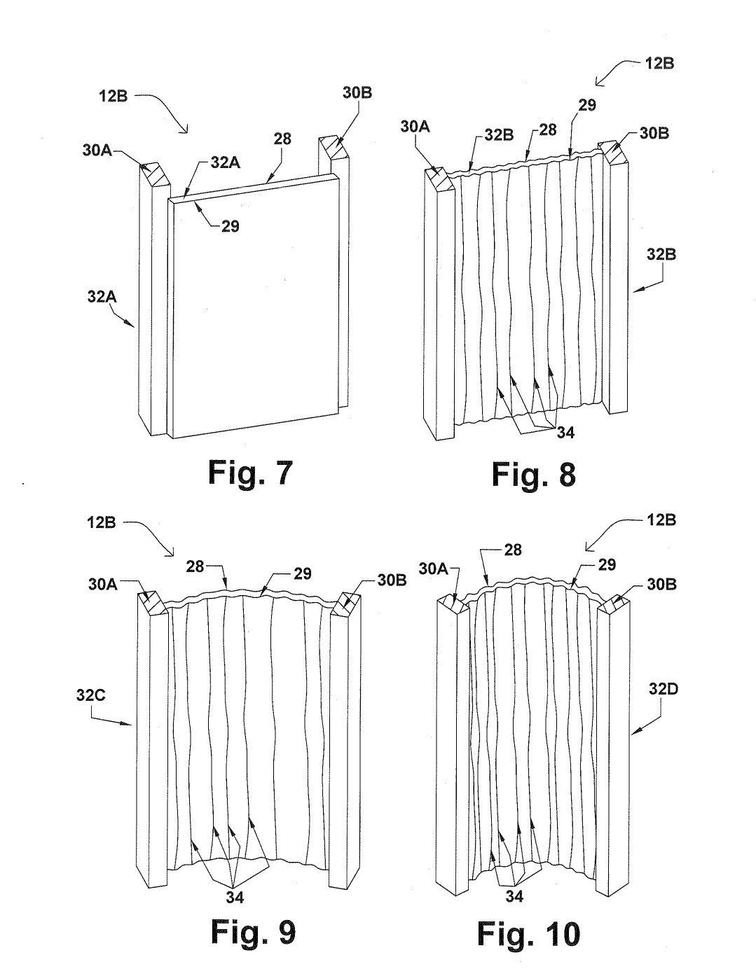

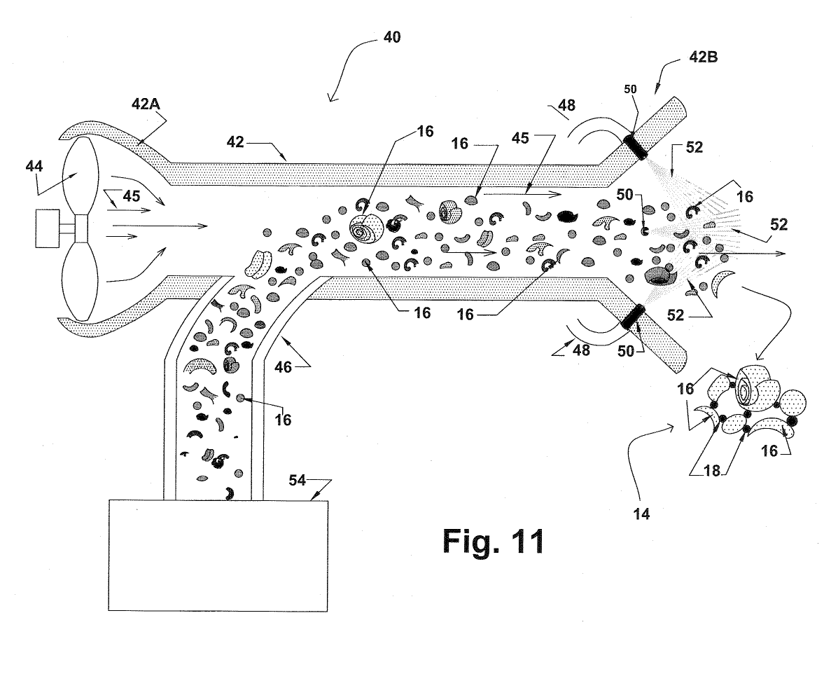

Referring to FIGS. 4-5, the thinner flexible skin 28 in combination with the pliable shredded plastic pieces 16 allow the panel 12B to conform to different spaces. FIG. 4 shows the recycled fill material 14 in a non-compressed condition similar to FIG. 3. In FIG. 4, the shredded plastic pieces of 16 are in a non-compressed state 32A and held together by adhesive 18 and the skin 28.

FIG. 5 shows the shredded plastic pieces 16 in a compressed state 32B where the fill 14 is compressed from opposite lateral sides by a force 36. In response to the opposing lateral forces 36, the skin 28 wrinkles 34 and the shredded plastic pieces 16 compress and deform. For example, shredded piece 16A compresses into a tighter roll and pieces 16B and 16C both flatten out and lengthen out. The air gaps 20 allow the plastic pieces 16 to move more freely and compress in different directions according to the direction of the compressive force 36.

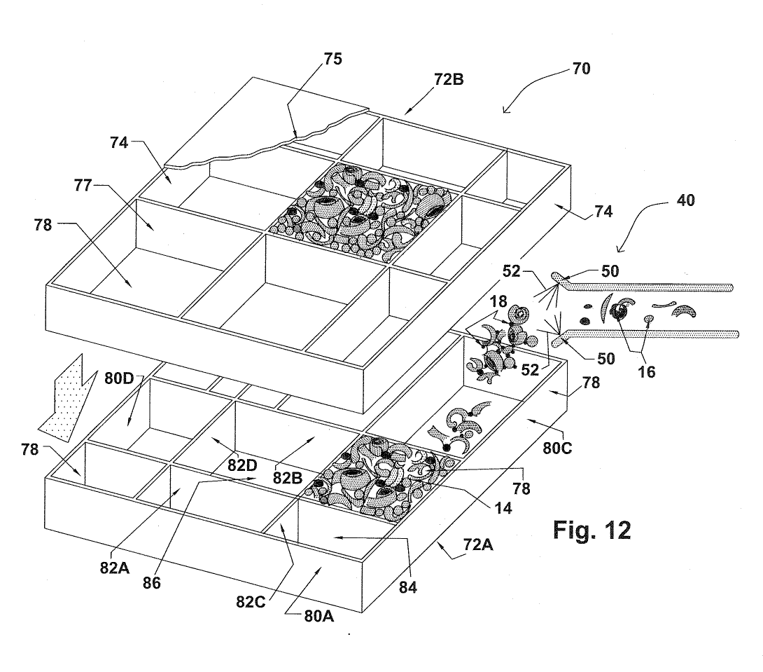

FIG. 6 shows the shredded plastic pieces 16 in a bent condition 32C where the panel 12B is slightly bent, for example, to reside in a corner. In bent condition 32C, the top skin 28 stretches and the bottom skin 29 compresses and creates wrinkles 34. Plastic pieces in the upper area 38A of panel 12B, such as piece 16D, expand outward to conform to the enlarged upper area 38A. Conversely, the plastic pieces in the lower area 38B of panel 12B, such as piece 16E, compress and move closer together to conform to the smaller lower area 38B.

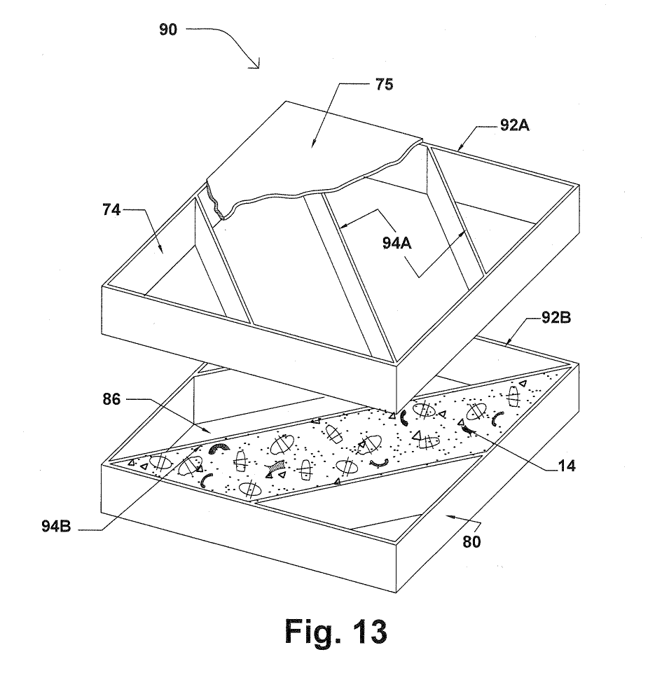

FIGS. 7-10 illustrate the different applications that may be used with the flexible panel 12B. FIG. 7 shows the non-compressed state 32A of panel 12B. In the non-compressed state 32A, the width of panel 12B is greater than the distance between wall joists 30A and 30B.

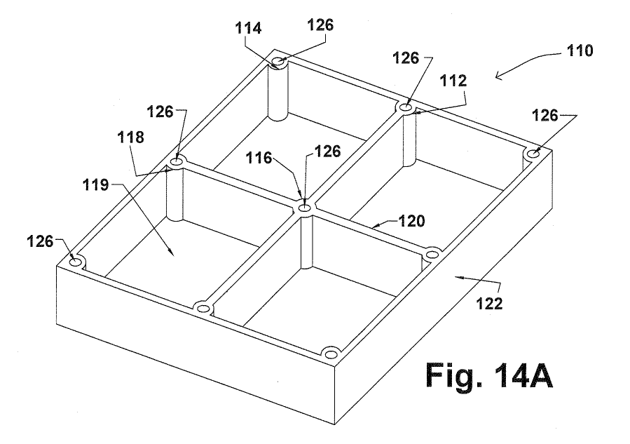

In order to fit panel 12B in-between the wall joists 30A and 30B, the panel 12B is compressed inward on opposite lateral sides. This reduces the width so that panel 12B can be inserted in-between the two wall joists 30A and 30B. As described above in FIG. 5, the back skin 28 and front skin 29 create wrinkles 34 while the shredded plastic pieces compress and move closer together. After being slid in-between wall joists 30A and 30B, the flexible skin 28 and 29 in combination with the shredded plastic pieces 16 then expand slightly outward toward their original shape shown in FIGS. 4 and 7. The panel 12B expands back outward until the sides snugly press out against the two wall joists 30A and 30B as shown in FIG. 8.

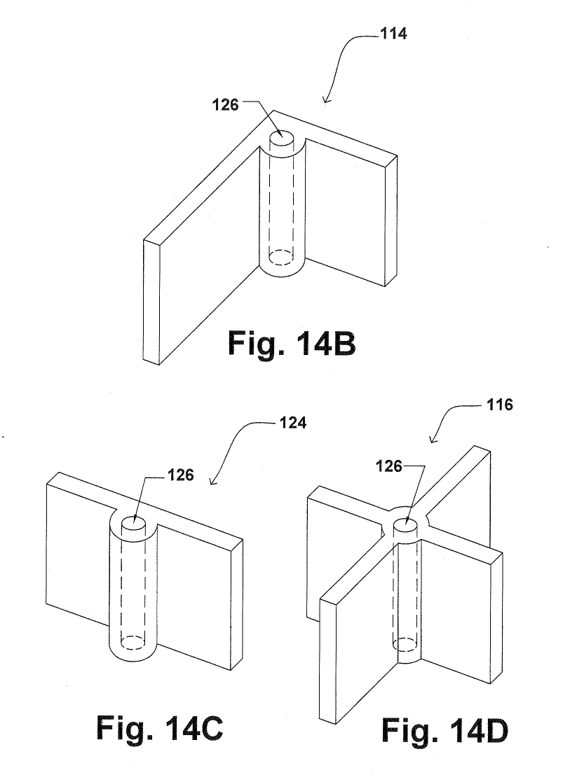

FIG. 9 shows the bent condition 32C of the flexible panel 12B as previously shown in FIG. 6. This bent condition may be used for example when inserting the panel 12B into a corner of a room. In this example, the panel 12B is bent forward causing the back skin 28 to stretch and the front skin 28B to compress creating wrinkles 34, The shredded plastic pieces 16 toward the back skin 28 expand and move laterally outward while the shredded plastic pieces toward the front skin 29 compress and move laterally inward.

The panel 12B can be inserted between wall joists 30A and 30B while in the bent condition 32C. After releasing the panel 12B, again the panel 12B may expand back and laterally outward until snugly pressing up against the two wall joists 30A and 30B.

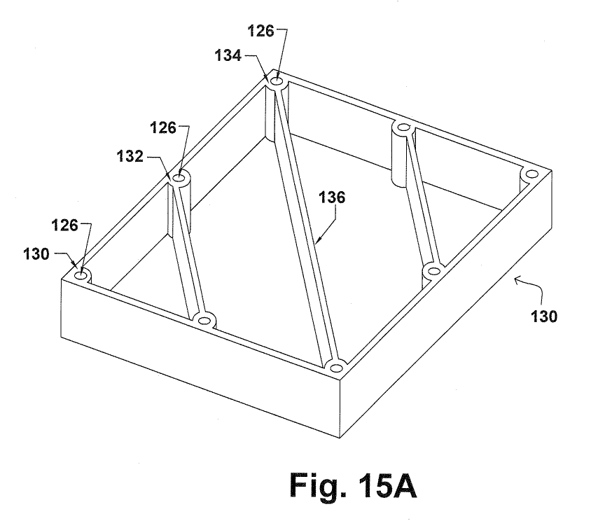

FIG. 10 shows a corner application similar to FIG. 9. In this case, the corner is more severely angled requiring the panel 12B to be bent in an approximately 45 degree arch. The back skin 28 is stretched even further than shown in FIG. 9 and the skin 28 is further compressed. The flexibility and arched shapes allow at least some of the shredded plastic pieces 16 near the back skin 28 to move and extend further laterally outward and allow the plastic pieces 16 near skin 29 to compress and move further inward. If adhesive is not used, then the shredded plastic pieces 16 are free to move in any direction that panel 12B is bent.

Different types of skins 28 and 29 may be used depending on the amount of bending, flexing and compression that may be required for the insulation panel. If extreme flexibility is required, the shredded plastic pieces 16 may either not be glued together, or glued together with a more elastically deformable glue. More flexible panels 12B can also be created by using a less concentrated amount of shredded plastic pieces 16, using larger shredded plastic pieces 16, or by using shredded pieces 16 that contain more plastic film and rubber materials.

Thus, the flexible panel 12B may be compressed and held more securely in-between support structures than say fiberglass insulation. Further, because the shredded plastic pieces 16 are completely contained within plastic skin 28, the panel 12B is easier to work with and cleaner than fiberglass insulation. The shredded plastic pieces 16 are also less caustic, less abrasive, and generally less objectionable than fiberglass insulation. The skin 28 and 29 can also be made in any variety of different colors or textures to provide a more aesthetically pleasing effect than fiberglass insulation. Thus, it may not be as necessary in some applications to even cover up the insulation panels 12B.

### Creating Insulation Fill

There are various ways that the fill material 14 can be manufactured. In one embodiment, the shredded plastic pieces 16 are mixed with glue in a container and then poured into the open panel enclosure or skin. The glue then dries holding the shredded plastic pieces 16 in any of the lattice configurations described above in FIGS. 2-6.

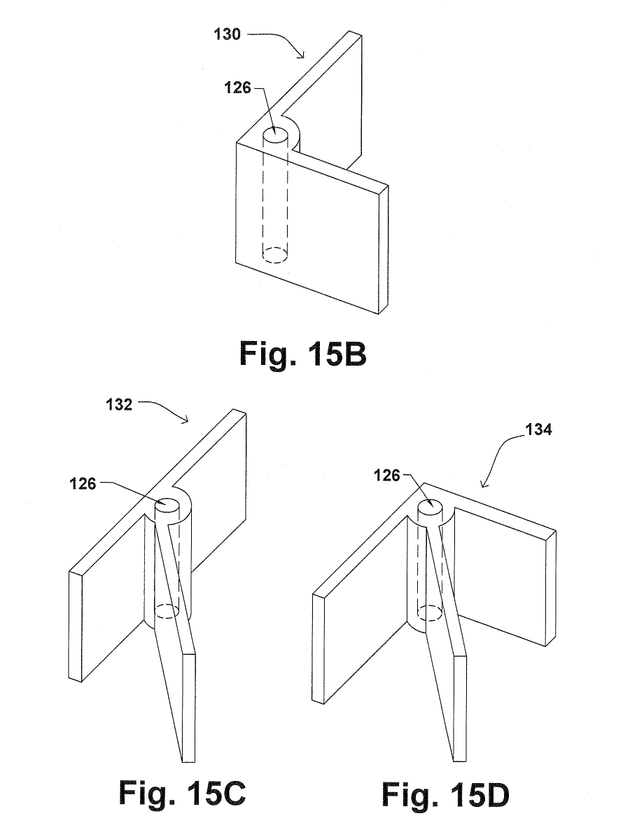

FIG. 11 shows another example of how the fill material 14 may be manufactured using an air gun 40. FIG. 11 is a simple schematic drawing used to illustrate a compressed air system for mixing the shredded plastic pieces with an adhesive. It should be understood that the compressed air source and other features of the air gun 40 described below would likely vary depending on the particular application and the embodiment shown in FIG. 11 is for illustrative purposes.

Referring to FIG. 11, the shredded plastic pieces 16 are stored in a bin 54 and an intake tube 46 is inserted into bin 54. Intake tube 46 is coupled to an air shaft 42 that has a first end 42A located next to a compressed air source 44. The compressed air source 44 is represented by a fan, however any other portable or installed air compression device or system could just as easily be used. The compressed air source 44 creates airflow 45 through air shaft 42 that produces negative pressure in intake tube 46 that draws the shredded plastic pieces 16 out of bin 54.

The shredded plastic pieces 16 are sucked through intake tube 46 and into air shaft 42. The air flow 45 from compressed air source 44 then blows the shredded plastic 16 out through a front end 42B of air shaft 42. Hoses 48 are attached to a tank (not shown) that contains an adhesive 18. Any type of adhesive could be used but one that maintains a certain amount of elasticity after drying may be preferred for at least some applications where the panel is deformable. For example, a non-flammable rubber cement may be used as adhesive 18. In other applications, a less elastic adhesive may be desirable. Both elastic and non-elastic adhesives are known and therefore are not described in further detail.

The adhesive 18 is atomized while being output from nozzles 50 as spray 52. The atomized adhesive spray 52 coats or coagulates onto the shredded plastic 16 while being blown out from end 42B of airshaft 42. The adhesive 18 causes the shredded pieces of plastic 16 to bind together either while being projected out from air shaft 42, or after being sprayed into the insulation panel 13. This is represented in FIG. 11 by the fill portion 14 that includes multiple different shredded pieces 16 that are adhered together by glue 18.

In an alternative embodiment, the adhesive 18 and shredded plastic pieces 16 are pre-mixed together in bin 54 and then blown out through end 42B of air shaft 42. After being shot out of end 42B, the adhesive covered shredded plastic pieces 16 immediately start to dry and bind together forming the random lattice structure existing in fill 14. Also, as described above, the mixture in bin 54 could be poured directly into the cavity of the insulation panel.

### Structural Panels

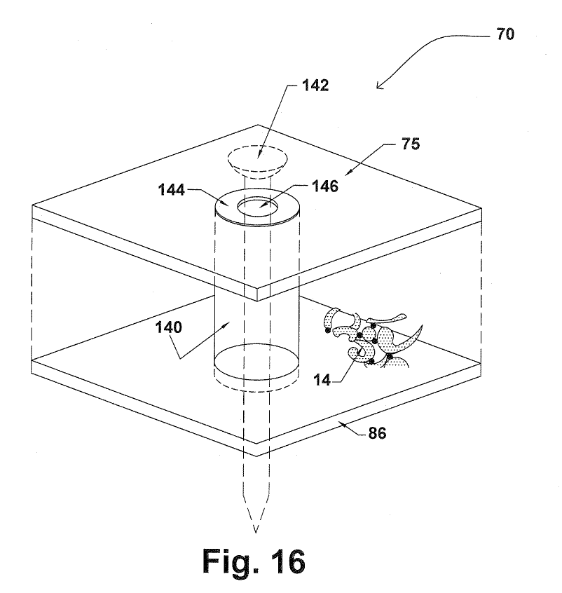

FIG. 12 shows one example of a more structurally rigid insulation panel 70. The panel 70 includes two sections 72A and 72B that are shown in an exploded disconnected condition. For illustrative purposes, the first panel section 72A is shown below the second panel section 72B just before the two sections are attached together. For explanation purposes, the first panel 72A is referred to as the lower panel and the second panel 72B is referred to as the upper panel. However, it should be understood that either one of the two panel sections 72A or 72B may be located underneath the other and that the two panel sections 72A and 72B may be attached together while standing on their sides. Further, after the two panel sections 72A and 72B are attached together, the panel 70 can be used in any vertical, horizontal or other angled position when attached to a wall, floor, ceiling, or other support structure; or when used as a freestanding wall, floor, ceiling, or other support structure.

The first lower panel section 72A includes side walls 80A-80D that extend vertically up from each side of a square or rectangular bottom wall 86. Ribs 82A-82D extend up from the floor 86 and extend perpendicularly from and between opposite side walls 80. In this example, the ribs 82C and 82D extend between front wall 80A and back side wall 80B and perpendicularly intersect with ribs 82A and 82B. Ribs 82A and 82B extend between opposite side walls 80C and 80D. In this example, the ribs 82 are asymmetrically spaced apart both from each other and also from the side walls 80A-80D. For example, the rib 82D is closer to wall 80D than the rib 82C is to side wall 80C. Rib 82A also is closer to front side wall 80A than rib 82BB is to wall 80B.

The upper panel 72B has the same asymmetric intersecting rib pattern as lower panel section 72A. An upper left corner of top wall 75 is shown in a partial cut away to show side walls 74 and ribs 77. The side wall 74 in upper panel section 72B extends downward from the top wall 75. Ribs 77 extend perpendicularly down from top wall 75 and extend perpendicularly between opposite side walls 74.

The panel sections 72A and 72B can be manufactured in a variety of different materials and techniques but in one embodiment are made from a fire retardant plastic material. The different walls and ribs for the panel sections may be formed or extruded from molds as a unitary piece of plastic or may alternatively be made in separate pieces and glued together. In one example, the walls and ribs for panel are all made from recycled plastic or rubber. Recycled plastic or rubber may be melted down and then poured into a mold to form the panel sections 72A and 72B.

The bottom wall 86, side walls 80, and ribs 82 in panel section 72A form multiple cavities 78 that are loaded with the recycled plastic fill 14. For clarity, only a few cavities 78 are shown with plastic fill 14. In one embodiment, the panel sections 72 are first all oriented similar to lower panel section 72A with the bottom wall 86 laid on the ground and the side walls 80 and ribs 82 extending vertically upward. The air gun 40 then sprays the fill 14 into the open cavities 78. As also described above, the shredded plastic pieces 16 can be pre-mixed with glue and then the mixture poured into the cavities 78. In another embodiment, the shredded plastic pieces 16 are simply poured into cavities 78 without using any glue.

One of the panel sections is then flipped over, as shown by panel section 72B. Glue is then spread along the open edges of the side walls and at the intersecting locations between the ribs 82 in lower section 72A and the ribs 77 in upper section 72B. The upper panel section 72B is then pressed down against lower panel section 72A with the side walls 80 and 74 in complainer alignment so the fill 14 in cavities 78 is completely contained within the bottom wall 86, top wall 75, and side walls 80 and 74.

The asymmetrically aligned ribs 82 and 77 provide the unexpected advantage of reducing or eliminating thermal bridging. For example, if the ribs 82 were co-planarly aligned with the ribs 77, then substantially continuous elongated ribs exist between the upper wall 75 and lower wall 86. These continuous ribs could be a source of thermal bridging where heat is transferred between opposite sides of panel 70. To reduce thermal bridging, the ribs are asymmetric so that the upper ribs 77 can be intentionally misaligned with the lower ribs 82 when the two panel sections 72A and 72B are attached together. This reduces the contact area between ribs 77 and 82 to small perpendicular intersections that substantially reduce the effects of thermal bridging.

The ribs 82 and 77 provide additional structural support for the panel 70, respectively, and can also maintain a more even distribution of fill 14 throughout the entire panel 70. For example, even if adhesive 18 is not used, the ribs 82 and 77 still restrict the amount of settling from the shredded plastic pieces 16.

The asymmetric arrangement of the ribs 82 and 77 allow panel sections of the same shape to be attached together as shown in FIG. 12 so that none of the ribs from the lower panel 72A and the upper panel 72B are co-planar. This provides further structural support between the lower wall 86 in panel section 72A and the upper wall 75 in upper panel section 72B. Of course, in other arrangements, the ribs could be symmetrically spaced apart from each other and symmetrically spaced apart from the side walls. In this arrangement, the ribs in the lower panel section 72A and the upper panel section 72B are in co-planar alignment.

In another arrangement only a single panel section 72 is used. For example, a top flat piece of plastic may be glued onto the top edges of the side walls 80 and ribs 82 of panel 72A. This type of panel would be approximately half as wide as the two section panel 70 shown in FIG. 12.

The side walls, top and bottom walls, and ribs may be different thicknesses depending on the application. For example, panel 70 may be installed and attached in-between wall joists as shown in FIG. 8. In this application, the side walls, top and bottom walls, and ribs may all be substantially thinner than other panels 70 used as part of a floor or free standing wall. Relatively thin walls and ribs may be less than 1/16^{th} inch thick. Alternatively, when used as a floor or as a free standing wall, the thickness of the side walls and ribs may be substantially more than 1/16^{th} inch thick. In another embodiment, thin pieces of plastic film may be used instead of molded plastic ribs 82 and 77.

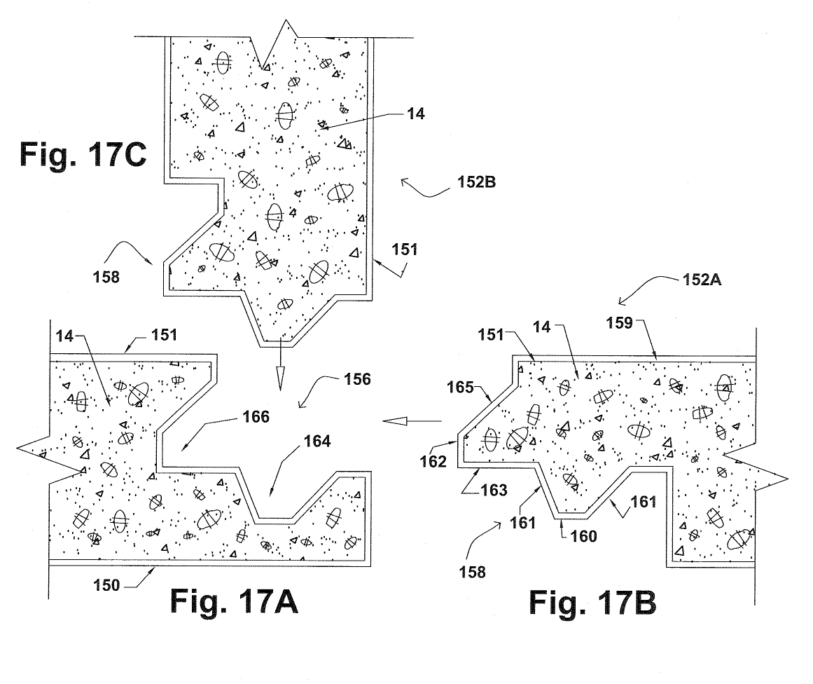

FIG. 13 shows another panel 90 that uses diagonal ribs 94. Again, for clarity, only one cavity of bottom panel section 92A is shown with fill 14. The bottom wall 86, top wall 75 and side walls 80 and 74 are all the same as described above in FIG. 12. However, the ribs 94A and 94B extend diagonally out from the side walls 74 and 80, respectively. Rotating the upper panel section 92A by 90 degrees aligns the ribs 94A perpendicularly with ribs 94B. These diagonal ribs 94 may provide more support when sheer forces are applied at different non-perpendicular angles against the panel 90.

In other embodiment, the perpendicular ribs 82 and 77 shown in FIG. 12 may be used in combination with the diagonal ribs shown in FIG. 13. In this embodiment, the diagonal ribs 94 in FIG. 13 may extend diagonally within the cavities 78 created by the perpendicular ribs 82 and 77 in FIG. 12. Any other combination of diagonal, perpendicular, or other shaped ribs can also be used.

### Installation

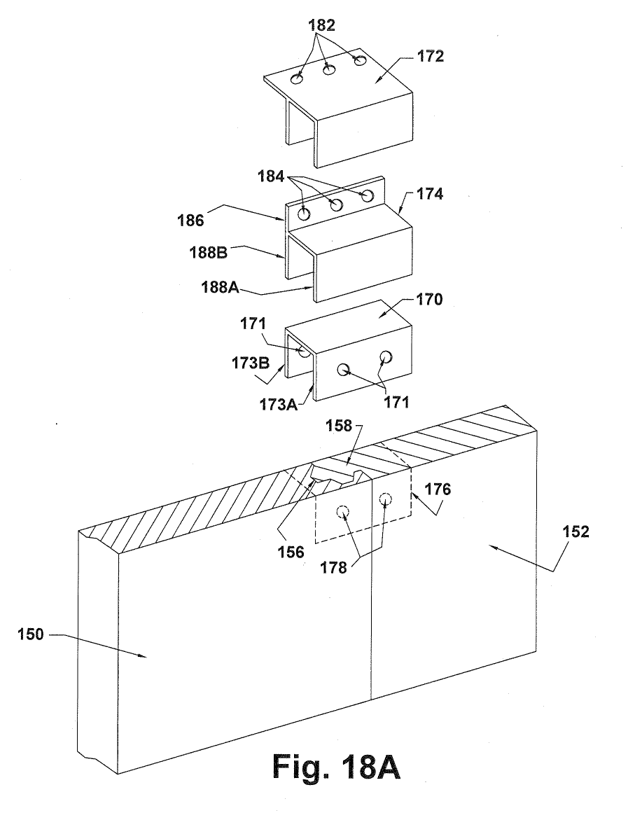

FIGS. 14A-14D show one example of how one of the panels 110 is installed to a wall, ceiling, floor or other supporting structure. A bottom wall 119, side walls 122 and ribs 120 are formed to include through holes 126. The panel 110 may be connected to another similarly shaped upper panel as described above in FIGS. 12 and 13, or may be used standalone with a top flat sheet attached over the open top end.

FIG. 14B shows an enlarged view of a corner thru-hole section 114, FIG. 14C shows an enlarged view of a side wall thru-hole section 124, and FIG. 14D shows an enlarged view of an intersecting rib thu-hole section 116. Again, the holes 126 in the thru-hole sections 114, 118, 124, and 116 can all be integrally formed into the panel 110 from a mold when the panel 110 is initially made. Otherwise, the holes 126 can be drilled into thicker plastic portions formed in the ribs 120 and side walls 122.

The sections 114, 118, 124, and 116 and associated holes 126 can be located and spaced 16 inches apart to align with conventional studs, ceiling joists, and floor joists. Of course, other thru-hole spacings or additional thru-hole spacings can also be provided. It should also be understood that not all ribs 120 need to include thru-holes. For example, to increase rigidity, additional ribs may be inserted between the ribs 120 shown in FIG. 14A. These additional ribs may or may not include pre-fabricated thru-holes.

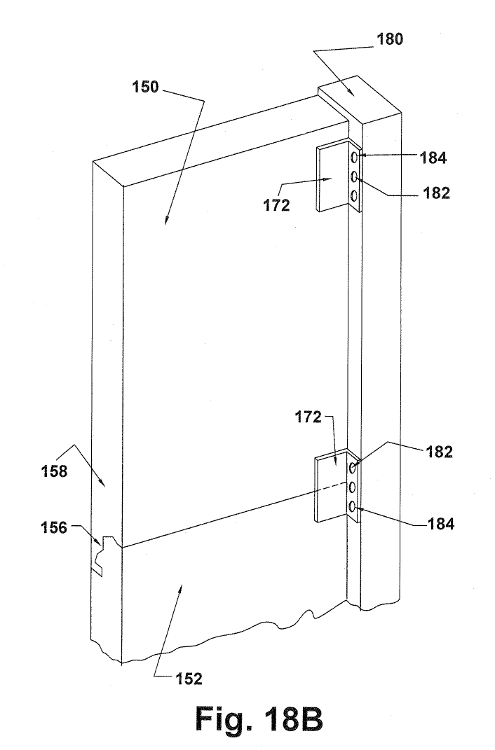

FIGS. 15A-15D show thru-hole sections 130, 132 and 134 formed in the sides and corners of a panel 130 with diagonal ribs 136. Again, the sections 130, 132 and 134 are molded or integrally formed during the manufacture of panel 130 and form holes 126 that extend completely thru the panel 130.

The panel 110 in FIGS. 14A-14D and/or the panel 130 in FIGS. 15A-15D are placed against a supporting structure such as a wall, floor, or ceiling. Nails or screws are inserted into the holes 126 and then either hammered or screwed, respectively, into the supporting structure. Any unused or unsealed holes 126 can be sealed or plugged with caulk or plastic plugs.

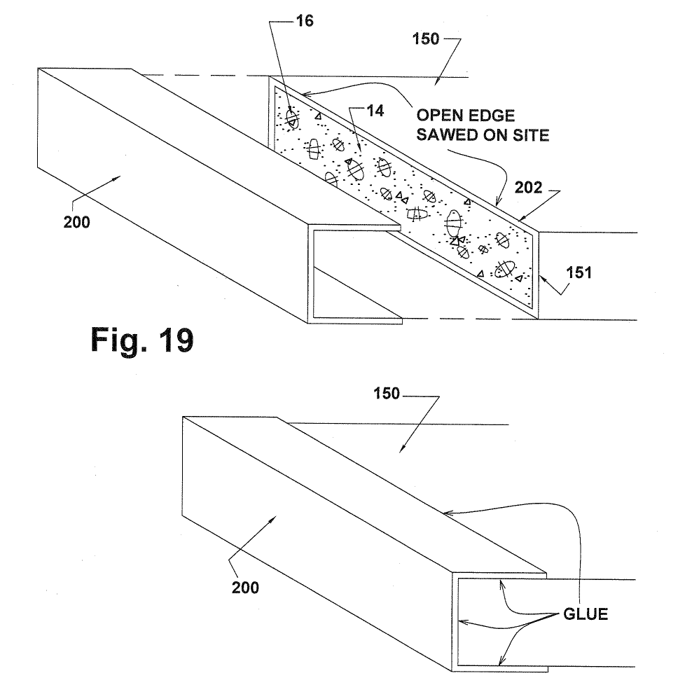

FIG. 16 shows one example of a plug 140 that is used for attaching any of the panels described above to a supporting structure. The plug 140 is shown located in the panel 70 previously described above in FIG. 12. However, the plug 140 can be used with any of the panels described above. A hole 144 is drilled through both the upper wall 75 and the lower wall 86 of panel 70. The plug 140 is inserted into hole 144 and glued to the walls 75 and 86. The plug 140 may also be made from recycled plastic and/or rubber and is formed with a hole 146 that extends completely thru the length of plug 140.

The panel 70 with the inserted plug 140 is placed against an associated supporting structure, such as a wall, floor, or ceiling. A nail or screw 142 is inserted into hole 146 and the nail or screw 142 is then hammered or screwed, respectively, into the supporting structure. The location of plug 140 can be aligned with a joist or stud so that that nail or screw 140 attaches more securely to the adjacent wall, floor or ceiling. The plug 140 also provides additional structural support between the top wall 75 and bottom wall 86.

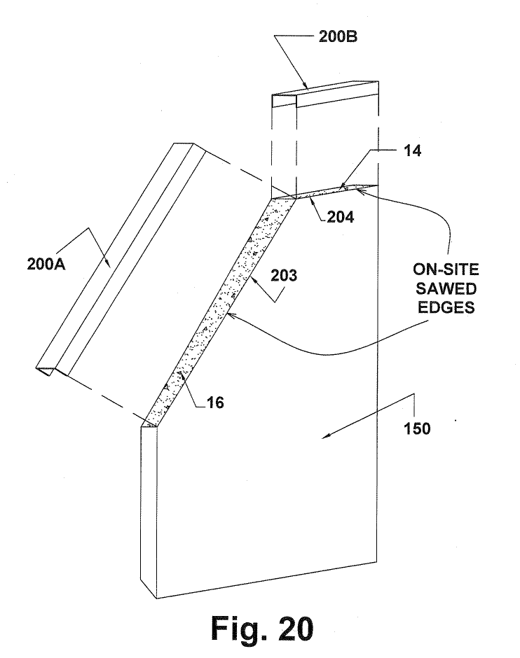

FIGS. 17A-17C show how ends of adjacent panels can be interlocked together. Panels 150, 152A, and 152B each include walls 151 that contain fill 14 as described above. The wall 151 on one end of panel 152A is formed into a first connection section 158 that includes a horizontal top side 159 and a downwardly directed protuberance 160 that extends downwardly from a horizontal bottom side 163. A laterally directed protuberance 162 extends laterally outward from the end of panel 152A. The downwardly directed protuberance 160 includes oppositely inclining sides 161 and the laterally directed protuberance 162 includes a downwardly inclining top side 165 that extends down to vertical end 162. The wall 151 in panel 150 is formed into a second connection section 156 that interlocks with first connection section 158. The second connection section 156 includes a first channel 164 that receives protuberance 160 and a second channel 166 that receives protuberance 162.

For a coplanar attachment, panel 152A is moved laterally from the side and possibly at a slight angle towards panel 150 until protuberance 162 inserts into channel 166 and protuberance 160 sits down into channel 164. For a 90 degree attachment, a panel 152B, similar to panel 152A, is flipped over and rotated 90 degrees to be aligned perpendicularly with panel 150. The connecting section 158 of panel 152B is then moved down into the connecting section 156 of panel 150.

The overlapping and interlocking connecting sections 158 and 156 while providing additional structure support also serve to improve the insulating characteristics between adjacent panels 150 and 152. For example, the non-uniform shapes of the connecting sections 158 and 156 prevent a straight air path between the front and back of the two connecting panels. Thus, air is less likely to pass through the interface of two connecting panels. Any seams between the adjacent panels 150 and 152, or seams between the panels and a support structure, can be caulked to provide a completely sealed insulation structure.

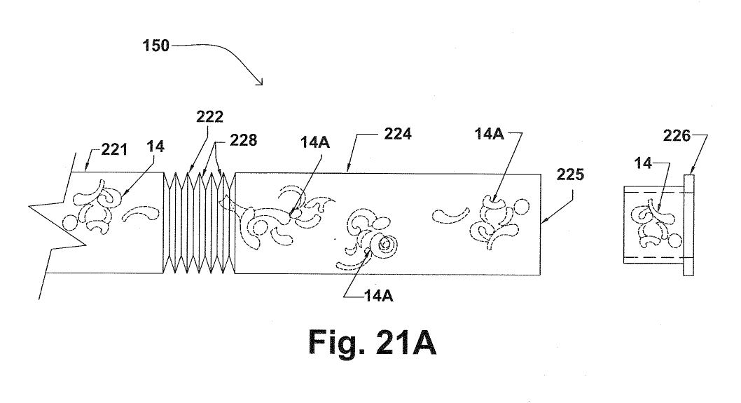

FIGS. 18A and 18B show how the panels 150 and 152 in FIGS. 17A-17C may be further coupled together. Different brackets 170, 172 and 174 can be used to further bind the two interconnected panels 150 and 152 together and to bind the two panels 150 and 152 to a supporting structure.

Referring first to FIG. 18A, the two panels 150 and 152 are interconnected together in a co-planer arrangement. After being interlocked together, the first connecting section 158 interlocks with the second retaining section 156. Any of the brackets 170, 172, or 174 can then be slid over the two connecting sections 156 and 158 at location 176. Bracket 170 may include holes 171 on both lateral ends of both front and back sections 173A and 173B. Nails, screws, or bolts are inserted through holes 171 in bracket 170 and holes 178 formed in panels 150 and 152 that are aligned with bracket holes 171.

Holes 178 in panels 150 and 152 may be prefabricated such as the holes shown in FIGS. 14 and 15. Alternatively, the holes 178 may be created by inserting plugs 140 as shown in FIG. 16 into selected locations in the panels 150 and 152 that align with the holes 171 in bracket 170.

Nails, screws, or bolts are then used to further bind panels 150 and 152 together. If panels 150 and 152 are used as a free-standing wall say for a utility building, a bolt may be inserted through holes 171 in bracket 170 and holes 178 in panels 150 and 152. Threaded ends of the bolts extending out through the back end of bracket section 173B are then locked down with nuts.

Referring still to FIG. 18A, the bracket 174 is similar to bracket 170 but includes a flange 186 with holes 184. The bracket 174 can be used to bind the top or side of panels 150 and 152 to a wall. In this embodiment, bracket 174 does not include holes in front and back sections 188A and 188B. In this arrangement, the bracket 174 is snugly slide over the two panels 150 and 152 and glued or force fit against the front and back walls.

Referring to FIG. 18B, in another application, the bracket 172 is used to attach the two panels 150 and 152 to a supporting structure 180. In this example, the supporting structure 180 is a wall or vertically aligned post. Several brackets 172 are slid over different locations of the two panels 150 and 152. While bolts, screws, or glue could be used, in this example, the width of brackets 172 are just slightly less than the width of panels 150 and 152. The brackets 172 are then force fit around the sides of panels 150 and 152.

Screws 182 are inserted thru the holes 184 in brackets 172 and screwed into the supporting structure 180. The panels 150 and 152 are held up vertically both by the combination of brackets 172, supporting structure 180, and the walls and internal ribs of the panels 150 and 152 as shown above in FIGS. 12-15. The brackets 172 could also be used to connect a top end of panel 150 to a ceiling or used to connect a bottom end of panel 152A to a floor.

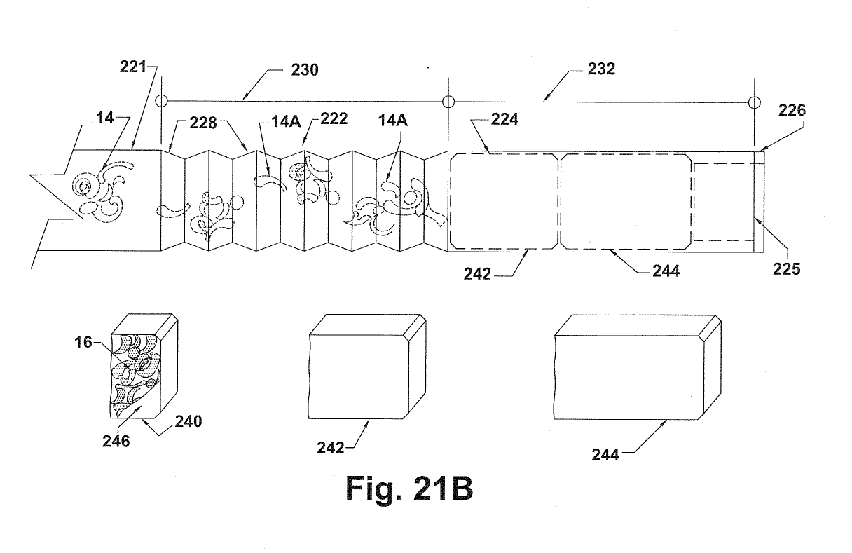

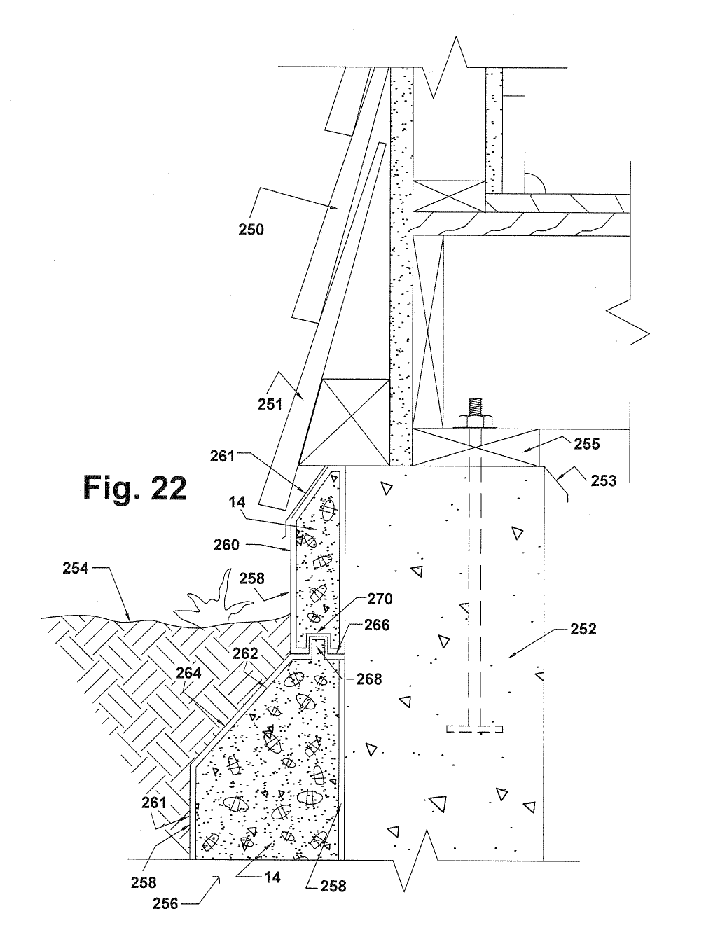

FIGS. 19 and 20 show how the panel 150 may be cut and trimmed to different shapes and sizes. The panel 150 can be cut or sawed as shown by sawed off edge 202. When an adhesive is used with fill 14, the individual shredded plastic pieces 16 near the end 202 of panel 150 are bound together inside of skin 151. This reduces the amount of plastic pieces 16 that fall out of panel 150 during the sawing process. Regardless of using adhesive, a cap 200 can be slid over cut end 202 and glued to the external walls of panel 150. The cap 200 can also be fabricated using recycled plastic and/or rubber material.

As shown in FIG. 20, the panel 150 can be cut into any shape. For example, a diagonal side 203 is cut from one corner of panel 150 and a horizontal top side 204 is cut from a top end of panel 150. Caps 200A and 200B are cut to match the length of corresponding sides 203 and 204, respectively.

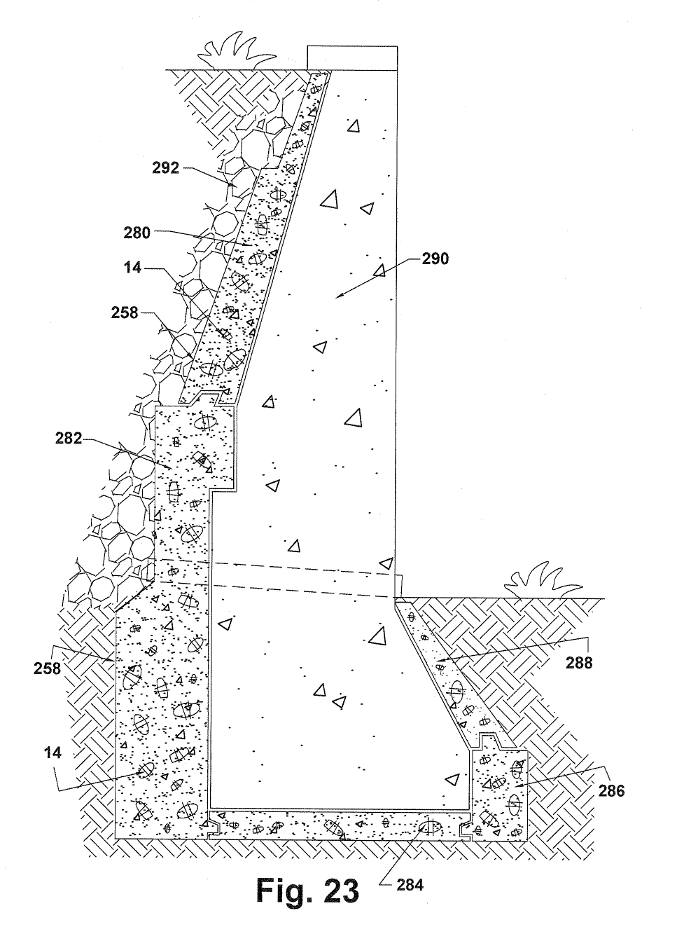

FIGS. 21A and 21B show another feature of the insulating panels. In this embodiment, a section 221 of the panel 150 is attached to one end of an expandable baffle 222 and a section 224 of panel 150 is attached to an opposite end of baffle 222. The baffle 222 in FIG. 21A is shown in a retracted position with folds 228 overlapped and folded closely together, in this position, section 224 of panel 150 may be completely full of shredded plastic fill 14. A cap 226 can be inserted into the end 225 of section 224 and in one embodiment may also contain fill 14.

The plastic baffle 222 operates similarly to a straw that includes a bendable top end. The multiple rigidly folded sections 228 unfold out into a rigidly retained extended position to extend out the second section 224 of the insulation panel 150. The baffle 222 is also retractable so that the sections 228 rigidly fold back over each other rigidly retaining the first and second sections 221 and 224 together in the retracted position shown in FIG. 21A.

A gap may exist between the end 225 of section 224 and an adjacent structure, such as a wall. Instead of cutting and attaching another panel to panel 150, in some instances it may be more beneficial to simply extend out end 225 to abut up against the adjacent structure. In this situation, the baffle 222 is extended outward as shown in FIG. 21B. Extending out baffle 222 moves the end 225 directly up against the adjacent structure.

In one embodiment, the fully extended baffle 222 may have a length 230 substantially equal to a length 232 of section 224. Extending out baffle 222 causes all of the fill 14A previously located in section 224 to now be located in extended baffle 222 as shown in FIG. 21B. Any additional unfilled space in section 224 caused by expanding out baffle 222 can then be filled with insulation pieces 240, 242, and/or 244.

Each insulation piece 240, 242, and 244 contains shredded plastic pieces 16 similar to those described above. The skin 246 of pieces 240, 242, and 244 may be a hard plastic or could be a more flexible tear resistant film such as described above in FIGS. 3-10. The thinner film skin 246 allows a few pieces 240, 242, and 244 of different sizes to be compressed into a variety of different compressible widths.

For example, extending the baffle 222 as shown in FIG. 21B may leave the entire section 224 empty since the fill 14A previously located in section 224 is now all located in extended baffle 222. Cap 226 can be removed and insulation pieces 242 and 244 inserted into now empty section 224. The cap 226 is then inserted back into the end of section 224 slightly compressing against the right end of insulation piece 224.

In another embodiment, shredded pieces of plastic can be loosely inserted into section 224 and cap 226 then inserted back into end 225 to retain the loose plastic pieces. Cap 226 is either force fit into end 225 of glued into end 225. In another embodiment small clumps of glued together shredded plastic pieces can be inserted into end 225 to fill up the empty portions of section 224.

The insulation pieces 240, 242, and 244 can be any width, length, or height, but in one embodiment the width and height are the same as panel 150. For example, for a 4 foot high and 6 inch deep panel 150, the pieces 240, 242, and 244 would each be 4 feet high and approximately 6 inches deep.

### Atypical Shapes

The pieces 240, 242 and 244 described above can also be used for smaller atypical spaces that may need custom insulation. As described above, the pieces 240, 242 and 244 may use a thin film as skin 246 similar to the plastic films used for grocery bags and have a compressibility similar to a pillow. The different bags 240, 242, and 244 can then be used to back-fill small awkwardly shaped places in a building or structure. For example, the bags 240, 242, and 244 can be placed around plumbing and electrical conduit or used to fill up awkward corners or holes in a home.

### Concrete Barriers

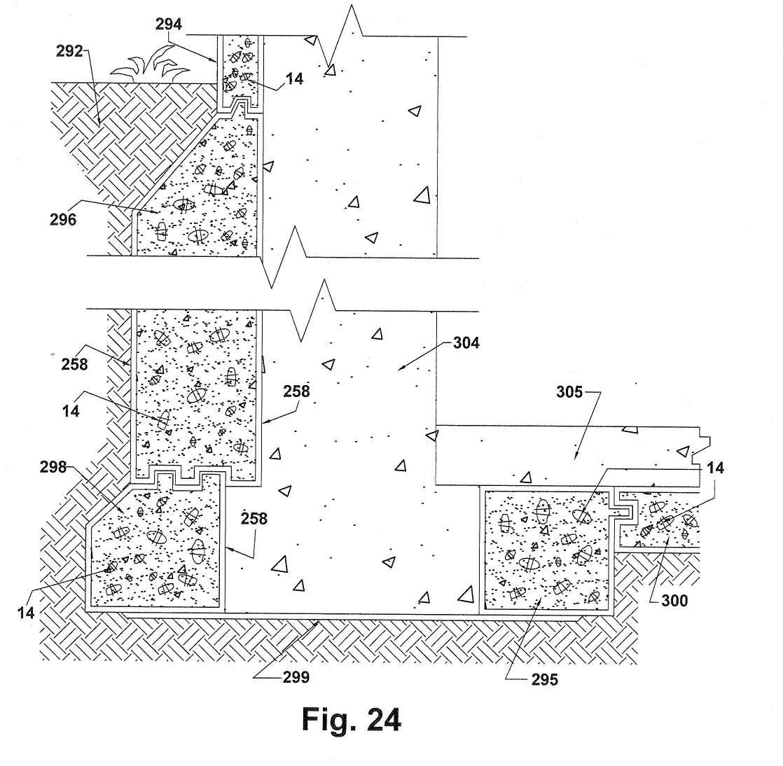

In another application, the insulation panels are used as concrete forms. The insulation panels/concrete forms are not only lightweight and easy to, but can also remain in the ground after the concrete is poured and dried to provide insulation and a protective barrier between the concrete and the ground. The panels can provide a barrier to almost anything including roots, insects, rodents, water, temperature, or even Radon gas. The panels described in FIGS. 22-24 are merely examples of essentially a limitless number of sizes and shapes that could be used as concrete insulation panels and/or forms.

Referring first to FIG. 22, a building 250 sits on top of foundation 252. Protective panels or forms 260 and 256 are used both to initially form the foundation 252 and then to provide a protective barrier between the foundation 252 and ground 254.

Form 256 is initially located in a hole that was previously dug into ground 254. A bottom end 261 of form 256 is wider than a top end 262 to provide additional support. An inclined side wall 264 extends from bottom side wall 258 up to a top end 266. The angled side wall 264 allows pressure from ground 254 to push both downward and laterally against form 256 causing the form 256 to firmly push up against the foundation 252.

The second form 260 sits on top of form 256 and presses against an upper part of foundation 252 that extends about ground 254. A rail 268 extends up from the top end 266 of form 256 and seats into a mating channel 270 located in the bottom end of form 260 interlocking form 256 with form 260.

The forms 256 and 260 can use the same fill 14 described above or may use some other recycled plastic material that provides a stronger structural rigidity. For example, the fill in forms 256 and 260 may be created by melting down recycled plastic and/or rubber and then forming a solid piece of rigid or semi-rigid plastic fill. The walls 258 used in forms 256 and 260 can be the same plastic material used for the panels described above. However, in one embodiment, the walls 258 may be thicker to increase the durability and structural rigidity.

Form 256 extends to the bottom of the foundation 252 (if the structure is built on a slab) or to the depth of the basement. The second form 260 interlocks with the top end 266 of the underground form 256 and extends to the height of the foundation sheath 253 approximately 6 to 8 inches above grade. The detail for the top 261 of form 260 can vary, depending on the type of construction.

The thickness of forms 260 and 256 provide a sufficient R-insulation rating to fully protect the joint between the top of the foundation footing 252 and the plate 255 that supports the exterior walls of building 250 and the ground floor. Form 260 when exposed can be supplied in a wide selection of colors and/or textures.

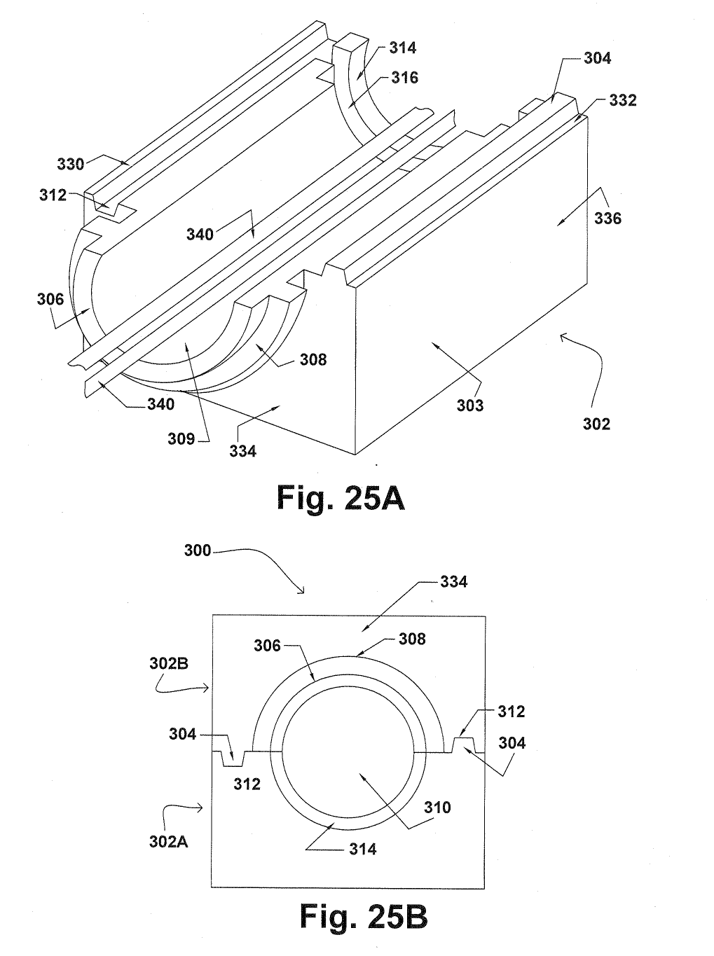

FIG. 23 shows multiple different panels or forms 280, 282, 284, 286 and 288 that are all attached together and completely surround the subterranean portion of a foundation, retaining wall, or any other material 290. FIG. 23 also shows how any variety of different panels 280, 282, 284, 286 and 288 can be made and used to conform around almost any concrete shape.

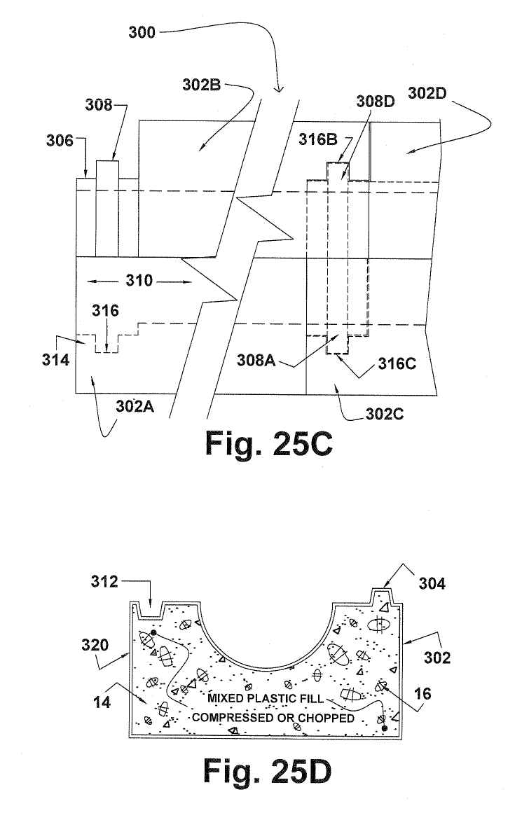

FIG. 24 shows other panel or form pieces 294, 295, 296, 298, 299 and 300 that provide a protective barrier around and underneath a concrete foundation 304 and concrete floor 305. Insulation/protection forms 294, 296, 298 and 295 are located on either side of the footing 304. Under the footing 304, a solid and very strong plastic skin 299 is laid down in the bottom of the excavation dug for the basement or foundation. The forms 298 and 295 located on opposite sides of footing 304 are laid on top of sheet 299 to provide a continuous barrier around the footing 304 protecting against Radon gas seepage, roots, rodents, water, etc. The footing form 295 located underneath the basement slab 305 interlocks with another form 300 also located underneath the basement slab 305.

The forms, panels, and plastic skin shown in FIGS. 22-24 provide a barrier around the buried concrete against water, roots, rodent, insect, Radon gas, etc. Since many types of plastic and rubber are not biodegradable and water resistant, the forms prevent ground water from seeping into the more porous concrete foundations. The forms and panels in FIGS. 22-24 also provide protection and insulation from water, ice, and temperature changes deteriorate the concrete foundation. The recycled plastic forms also provide a protective barrier from insects that may normally burrow through parts of the foundation. The increased size of the forms shown in FIGS. 22-24 also provide more space for plastic fill material 14 thus removing these non-biodegradable materials from landfills and turning them into useful building products.

### Conduit and Pipe Insulation

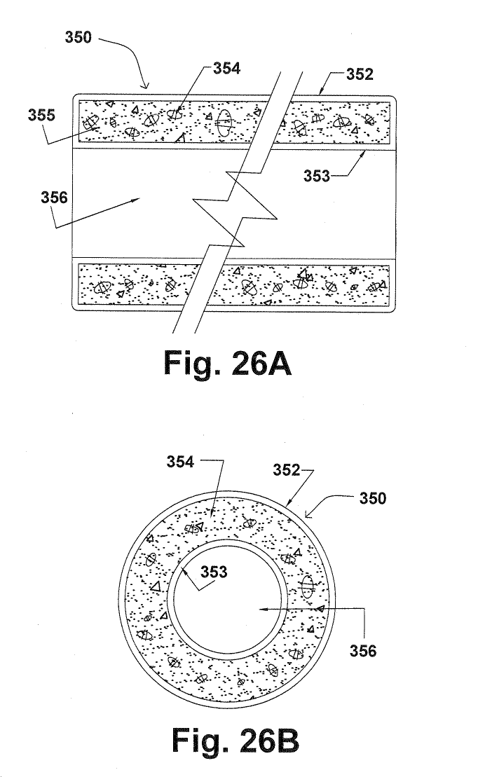

The recycled plastic insulation materials described above can also be used as a conduit or pipe. Referring to FIGS. 25A-25D, multiple conduit sections 302 are assembled together to form a conduit 300. Each conduit section 302 includes a substantially rectangular base 303 that includes vertical front and back walls 334 and vertical side walls 336. A top end is formed into a half-circular trough 309 that extends long the entire length of section 302. Any shape could be used for base 303 including a round shape, octagonal shape, or a rectangular shape with rounded edges. The rectangular shape of base 303 is shown in FIGS. 25A-25D merely one example.

An elongated channel 312 extends along the entire length of first horizontal top side 330 of conduit section 302. An elongated rail 304 extends along and above the entire length of a second opposite horizontal top side 332 of conduit section 302. A half-circular lip or flange 306 extends out over the front wall 334 of conduit section 302 and includes a ring 308 that extends around an outside surface of lip 306. A half-circular channel 316 is formed in the back end 314 of each conduit section 302. The back end 314 is configured to interlock with the flange 306 of another conduit section 302.

FIG. 25D shows a cross-section of conduit section 302. A wall 320 is formed from recycled plastic or some other rigid material. The compartment formed by wall 320 contains fill 14 as described above that in one embodiment is shredded, compressed, and/or chopped recycled plastic pieces 16.

FIG. 25B shows a front view of two conduit sections 302A and 302B after being interlocked together. The rail 304 in upper conduit section 302B is inserted into the channel 312 of lower conduit section 302A. Similarly, the rail 304 in lower conduit section 302A is inserted into the channel 312 formed in upper conduit section 302B. The front flange 306 of upper conduit section 302B is aligned above the channel 316 and rear end 314 of lower conduit section 302A. The two conduits sections 302A and 302B when assembled together form a round interior hole 310 that extends along the entire length of conduit 300.

Referring now to the side view in FIG. 25C, other conduit sections, such as section 302C and section 302D, are assembled similar to sections 302A and 302B so that the rim 308A of the conduit section 302A inserts into the channel 316C of conduit section 302C. Conduit section 302D sits on top of conduit section 302C in an opposite orientation so that the rim 308D of conduit section 302D inserts into the channel 316B in conduit section 302B.

The different conduit sections 302 can be glued together, clipped together, or simply held together from the weight of earth that may be used to cover the conduit 300. The removable top sections allow easier insertion and removal of pipes, electrical power cables, fiber optic cables, or any other type of communication cable, pipe, or power cable.

For example the bottom sections 302A and 302C of the conduit 300 shown in FIG. 25C can be laid down on the ground and then interlocked end to end. Pipe and/or cables 340 can then be laid in the half open troughs 309 formed in the bottom sections 302A and 302C as shown in FIG. 25A. After the cables and/or pipes 340 are laid in trough 309, the upper conduit sections 302B and 302D are laid over and interlocked with lower conduit sections 302A and 302C.

If the cables or pipes 340 ever have to be removed or worked on, the upper conduit sections 302B and 302D can be simply lifted off the lower conduit sections 302A and 302C. After the cables or pipes 340 are added, removed, or maintained; the upper conduit sections 302B and 302D are moved back on top of the lower conduit sections 302A and 302C.

The removable and replaceable conduit sections 302A-302D are easier to use than conventional conduit that requires cables to be threaded through the middle of an enclosed pipe. The plastic walls 320 and shredded plastic filler 14 inside of the conduit 300 is also more resilient to decomposition and more water resistant than conventional ceramic conduits. The conduit 300 is also lighter and thus easier to install while at the same time providing better insulation for any contained pipes or cables 340 and providing a barrier for roots, rodents, insects, etc. In one example, the conduit 300 could replace or encase relatively fragile terracotta pipes.

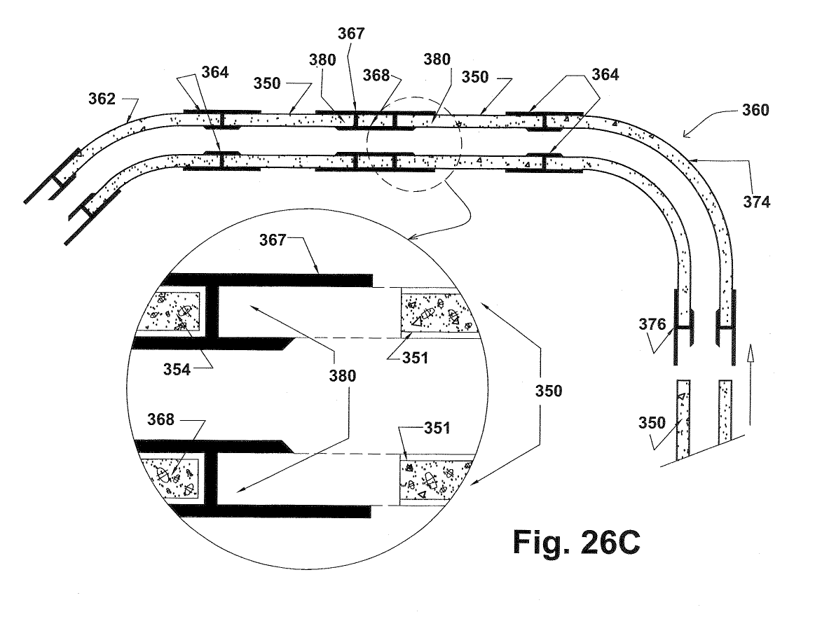

FIGS. 26A-26C show one example of an insulated pipe 350 that also uses recycled shredded plastic. FIG. 26A shows a side-sectional view of the pipe 350 and FIG. 26B shows a cross-sectional view of pipe 350. An outside plastic tube 352 contains a concentrically aligned inside plastic tube 353. The space 355 between the two tubes 352 and 353 contains recycled plastic fill 354.

The fill 354 may still be plastic pieces, but may be shredded into finer pieces than some of the other embodiments described above. Alternatively, the shredded plastic pieces may be exactly the same as the shredded plastic 16 described above. The tubes 352 and 353 can be made from virgin or recycled plastic or PVC. In other embodiments, the fill 354 could be foam or some other insulating material.

The fill 354 insulates any fluid or gas carried in pipe 350 better than conventional single walled PVC or metal pipe. For example, many homes today have instant hot water systems where hot water is constantly cycled through water pipes so that hot water taps instantly provide hot water. A large amount of heat is lost while hot water is cycled through hot water pipes. The improved insulation provided by pipe 350 substantially reduces energy loss in both instant hot water systems and in conventional hot water systems.

FIG. 26C shows several pieces of the insulated pipe connected together. Various shapes and lengths of dual-walled insulated pipe can be manufactured and various shapes and sizes of couplers 364, 367 and 376 can be used for connecting the different insulated pipes together. For example, straight pipe sections 350 are connected together with coupler 367.

The coupler 367 contains a circular slot 380 that slidingly receives ends 351 of pipe 350. The ends 351 of pipe 350 and coupler 367 can be glued together. In one embodiment, the connector 367 includes circular slots on opposite ends that are separated by a section 368 that contains fill 354.

Other connectors 364 have circular slots on both ends but no insulated sections 368 in-between the two circular slots. Other pipes, like elbow 374 may have a circular slot connector 376 formed on one or both ends.

### Applications

The shredded plastic insulation can be used for any insulation application or for any other application where it may be advantageous to use recycled plastic. Some other applications, in addition to the applications described above are briefly mentioned below.

1. Rigid insulated panels for internal uses. The insulated panels can be used as internal walls, ceilings and floors and can be used as replacements for sheets of plywood, sheets of fiberglass, sheetrock, or floorboards.
2. External rigid insulated sheathing and panels. This includes replacements for external plywood sheathing, sheets of fiberglass or aluminum, or free standing building walls such as for agricultural outbuildings, barns and other industrial or utility buildings. When used as walls, ceilings, or floors of a building, the insulation panels may be pre-wired and pre-plumbed.
3. Internal and external insulation. The panels described above can replace just about any current insulation product and increase insulation while at the same time providing additional structural utility.
4. Insulated pipes. Insulated water pipes can replace standard PVC, aluminum, steel, copper, bronze, or cast iron water pipes and can replace wrapped insulated pipes. Due to the improved insulation provide by the shredded plastic, the insulated water pipes provide additional protection against damage due to freezing water and prevent having to bury pipes deep underground. As described above, the insulated piping also reduces energy loss, such as for the hot water pipes used in instant hot water systems as well as better maintaining lower temperatures in cold water pipes.
5. Interlocking or telescoping panels. The baffles and interconnecting embodiments described above provide improved insulation by reducing air gaps between adjacent panels and reducing air gaps between an insulation panel and a support structure such as a beam, wall, or ceiling.
6. Flexible insulation panels. The flexible panels also described above can be used in corners of structures such as for insulating and sealing joints between roofs, walls and floors.
7. Swimming pools. The insulated forms and panels can be used with above ground or below ground swimming pools. Above ground pools can use the recycled shredded plastic in-between inner and outer walls of the swimming pool. Below ground swimming pools can first use the insulated forms described above in FIGS. 22-24 as a concrete form for pouring the concrete pool. After the pool concrete is built, the forms then serve to insulate and provide a barrier between the pool and the ground.
8. Insulated conduit. The insulated conduit described above in FIGS. 25A-25D insulates cable and pipes from extreme temperatures and also protect the pipes and cables from water, insects, burrowing animals, plant roots, etc.
9. Insulated vaults. The insulated panels can be used as underground vaults that protect devices such as utility meters, sprinkler valves, or even caskets from the environment.
10. Modular insulated subway sections. The interlocking pre-fabricated insulated conduits and insulate panels can also be used for pedestrian tunnels, walkways, subways, and utilities.
11. Shipping containers. The interlocking panels can be assembled into a limitless variety of different container sizes and then used as shipping containers that insulate ship cargo from harsh ocean environments.
12. Underground malls and dwellings. Underground dwellings are becoming more popular both for energy efficiency and for protection against hurricanes and other hazardous environmental conditions. The concrete forms described above when installed underneath these underground dwelling provide protection against ground water, rodents, insects, radon gas while also providing additional insulation.

The shredded plastic filler described above uses shredded recycled plastic. The skin, or casing, can also be made either from new or recycled plastics or polyurethanes of varying thicknesses. Many plastics are not currently being recycled, or are collected only to be thrown into landfills. The insulated panels and forms described above provide a new use for some of these plastic materials that are currently some of the most problematic materials in solid waste disposal.

The shredded plastic filler described above require little or no chemical processing, does not consume any significant energy during fabrication, and does not require the mining or use of raw materials. The only processing required is shredding used plastic, rubber, or foam material into slivers, bands, and other various random sizes and shapes so that when combined together the resulting filler provides an optimum amount of insulating air pockets. Thus, manufacturing the insulated panels, forms, conduits, and/or pipes is relatively inexpensive and environmentally friendly.

Having described and illustrated the principles of the invention in a preferred embodiment thereof, it should be apparent that the invention may be modified in arrangement and detail without departing from such principles. I/We claim all modifications and variation coming within the spirit and scope of the following claims.

1. A recycled insulation material, comprising:
plastic and/or rubber shredded or chopped up into individual pieces having random or semi-random sizes and lengths that when combined together create random or semi-random air-pockets in-between many of the individual pieces, the shredded or chopped up plastic and/or rubber pieces in combination with the air-pockets created between the shredded and/or chopped up plastic and/or rubber pieces configured to operate as an insulation filler.

2. The recycled insulation material according to claim 1 wherein at least some of shredded and/or chopped up plastic and/or rubber pieces when combined together are configured to resiliently deform against each other when compressed together and at least partially reform back into their original shapes when decompressed.

3. The recycled insulation material according to claim 2 wherein at least some of shredded and/or chopped up plastic and/or rubber pieces have curved shapes that partially flatten out when compressed together and then at least partially expand back out into their curved shapes when decompressed.

5. The recycled insulation material according to claim 2 wherein at least some of the plastic and/or rubber pieces are shredded and/or chopped up recycled plastic bags, recycled plastic bottles, or recycled tires.

6. The recycled insulation material according to claim 1 wherein the shredded and/or chopped up plastic and/or rubber pieces are glued together at different random locations creating a resiliently deformable lattice.

7. The recycled insulation material according to claim 6 wherein the shredded and/or chopped up plastic and/or rubber pieces are blown into a spray of glue, the spray of glue coating or coagulating on the shredded and/or chopped up plastic and/or rubber pieces causing the plastic and/or rubber pieces to adhere together after being blown through the spray of glue.

8. The recycled insulation material according to claim 1 wherein shredded and/or chopped up plastic and/or rubber pieces are approximately between ⅛^{th} inch and ½ inches long.

9. The recycled insulation material according to claim 1 including an enclosure having walls that form a containment area, the enclosure configured to attach to a structure and the containment area configured to hold and contain the shredded and/or chopped up plastic and/or rubber pieces.

10. An insulation panel, comprising:
a plastic enclosure; and
shredded or chopped up plastic and/or rubber combined together to provide an insulation filler for the enclosure.

11. The insulation panel according to claim 1 wherein the enclosure comprises a stretchable and compressible plastic film that when filled with the shredded and/or chopped up plastic and/or rubber create a compressible and deformable insulation panel.

12. The insulation panel according to claim 10 wherein the enclosure comprises rigid plastic side walls, plastic top and bottom walls, and plastic ribs that extend between opposite sides walls and between the top and bottom walls to form cavities that retain the shredded or chopped up plastic and/or rubber.

13. The insulation panel according to claim 10 further comprising:
a first panel having a bottom wall, side walls that extend up from sides of the bottom wall, and ribs that extend between the side walls forming cavities that are filled with the shredded or chopped up plastic and/or rubber; and
a second panel having a bottom wall, side walls that extend up for sides of the bottom wall, and ribs that extend between the side walls forming cavities that are filled with the shredded or chopped up plastic and/or rubber, wherein a top open face of the first panel is glued to a top open face of the second panel.

14. The insulation panel according to claim 10 further comprising:
a first end having a connection section including a first protuberance extending laterally out from a first vertical face and a second protuberance extending down and out from a second horizontal face; and/or
a second end having a connection section including a first channel extending into a first vertical face for receiving the first protuberance and a second channel extending into a second horizontal face for receiving the second protuberance.

15. The insulation panel according to claim 10 further comprising a plastic baffle located between a first and second section of the insulation panel, the baffle including multiple rigidly folded sections that unfold out into a rigidly retained extended position to extend out the second section of the insulation panel, the baffle configured to also be retractable so that the folded sections rigidly fold back over each other rigidly retaining the first and second sections together in a retracted position.

16. The insulation panel according to claim 10 wherein the panel includes plastic walls that both contain the shredded or chopped up plastic and/or rubber and provide a free standing support structure for supporting the panel in an upright vertical position.

17. An apparatus, comprising:
multiple concrete forms or panels each having a relatively hard plastic outside shell that is filled with recycled shredded or chopped plastic pieces, the multiple forms connected together to provide a concrete form or panel for forming or protecting concrete.

18. The apparatus according to claim 17 wherein:
a first concrete form has a top end, a first vertical side wall that extends vertically down from the top end and is configured to press up against the concrete, a second vertical side wall that is substantially parallel to the first side wall, and a third diagonal wall that extends diagonally up from the third vertical wall to the top end; and
a second concrete form has a bottom end that interconnects with the top end of the first concrete form, a first vertical side wall that extends vertically up from the bottom end and presses up against the concrete, and a second vertical side wall that is substantially parallel to the first vertical side wall.

19. The apparatus according to claim 17 including a plastic sheet that is located underneath the concrete and multiple concrete forms or panels that are located on sides of the concrete, the plastic sheet and multiple concrete forms or panels joined and/or interlocked together to extend around the concrete between the concrete and the ground.

20. A conduit, comprising:
multiple plastic conduit sections each having side walls and an top section that contains an elongated trough that extends along a length of the conduit sections, a first one of the conduit sections flipped over to sit on top of a second one of the conduit sections to form a hole for retaining pipes or cables.

21. The conduit according to claim 20 wherein the multiple conduit sections are hollow and filled with shredded or chopped pieces of plastic and/or rubber.

22. The conduit according to claim 20 wherein the multiple plastic conduit sections each include:
a front end having a flange or lip that extends out over a front vertical face; and
a back end having a mating section that interlocks with the flange or lip from another one of the plastic conduit sections.

23. An insulated pipe, comprising:
a first exterior plastic tube;
a second interior plastic tube inside and spaced apart from the first exterior tube; and
recycled plastic and/or rubber pieces inserted between an elongated circular space between the first and second plastic tubes.

24. The insulated pipe according to claim 23 including a connector comprising circular slot for receiving the first and second plastic tubes.

25. The insulated pipe according to claim 24 wherein a first end of the connector includes a first circular slot for receiving ends of the first and second plastic tubes for a first insulated pipe and a second end of the connector includes a second circular slot for receiving ends of the first and second plastic tubes for a second insulated pipe.
